(19) United States
(12) Patent Application Publication
(10) Pub. No.: US 2002/0036673 A1
(43) Pub. Date: Mar. 28, 2002

(54) INK JET HEAD AND PROCESS FOR PRODUCING THE SAME

(75) Inventors: KOZO MIYOSHI, TOKOROZAWA-SHI (JP); AYAKO KAZAMA, TOKOROZAWA-SHI (JP); KEISUKE KIGAWA, TOKOROZAWA-SHI (JP); YORINOBU YAMADA, TOKOROZAWA-SHI (JP)

Correspondence Address: FINNEGAN HENDERSON FARABOW, GARRETT & DUNNER, 1300 I STREET NW, WASHINGTON, DC, 20005

(73) Assignee: Citizen Watch Co., LTD

(21) Appl. No.: 08/849,695

(22) PCT Filed: Sep. 20, 1996
(86) PCT No.: PCT/JP96/02727

(30) Foreign Application Priority Data
Apr. 11, 1996 (JP) 8-89189
May 13, 1996 (JP) 8-117502
Jun. 28, 1996 (JP) 8-169288

(51) Int. Cl. B41J 2/135

(52) U.S. Cl. 347/45

(57) ABSTRACT

An ink jet head, for use in an ink jet recording apparatus, comprising an ink chamber, a member constituting the ink chamber being made of a plastic material having a surface possessing a hydrophilic nature imparted by surface treatment, for introducing a polar group, selected from the group consisting of acid treatment, ultraviolet light-ozone irradiation, and oxygen plasma treatment, and a process for producing the same. When the ink jet head is used in an ink jet printer using a water-base ink, the wettability of an ink flow passage within the head is good and, in addition, the good wettability can be stably maintained, permitting a high print quality to be ensured for a long period of time.

### TECHNICAL FIELD

The present invention relates to an ink jet recording apparatus, that is, an ink jet head for use in an ink jet printer, and a process for producing the same. When the ink jet head according to the present invention is utilized in an ink jet printer using a water-base ink, the wettability of an ink flow passage within the head is good and, in addition, the good wettability can be maintained for a long period of time, enabling high print quality to be ensured for a long period of time.

### BACKGROUND ART

It is well known in the art that, in an ink jet printer, an ink is ejected through very small nozzles mounted on a front end of an ink jet head and ink droplets are propelled onto the surface of paper, films or other recording media to record letters, figures, patterns or the like on the surface thereof. In this case, water-base inks are generally used as the ink. Regarding the recording system in this ink jet printer, various systems are currently known depending upon a method for forming ink droplets, a method for generating ejection energy and the like. For example, in a charge control type recording system, a piezoelectric device (piezo device) is utilized, and pressure waves are created in an ink chamber of the head filled with an ink by taking advantage of vibrating force of the device and eject the ink. Other systems known in the art include electromechanical conversion, electrothermal conversion, static electricity-driven ejection, and electric discharge systems. The ink jet printer has many advantages, and typical examples thereof include, for example,

noncontact printing being possible;

printing being possible on various recording media;

low running cost because plain paper is usable;

easy color printing;

sharp color reproduction;

reduced noise during printing; and

high speed printing.

One drawback of the ink jet printer is that printing is likely to be influenced by an environment where the printer is placed. For example, a fluctuation in temperature or humidity of the ambient environment causes a change in properties of the ink, resulting in unstable ejection of ink droplets and clogging of nozzles due to drying. An additional drawback of the ink jet printer is to be likely to be influenced by foreign materials and air bubbles. The foreign materials included in the head often cause clogging of the ink flow passage and the nozzle. The formation of air bubbles often makes it impossible to eject the ink.

As described above, the ink used in the ink jet system is mainly a water-base ink. In the ink jet head, when the hydrophilicity of an ink flow passage provided in the head is low, there is a possibility that air bubbles are likely to be formed within the ink flow passage at the time of filling of a water-base ink into the head. The air bubbles strongly adhere to the wall surface of the flow passage and cannot be easily removed even by suction of the ink. When the air bubbles remain in the ink flow passage, troubles occur including, in addition to non-ejection of the ink, dropouts and ejection of ink droplets with undesired trajectories, deteriorating the print quality.

Unsatisfactory hydrophilicity in the ink flow passage is associated also with a member constituting the ink head. In recent years, plastic materials are mainly used as the member for constituting the ink head. This is because the plastic materials have many advantages including that they are inexpensive, the moldability and fabricability are good, they can be mass-produced and have excellent strength and chemical resistance, and welding is usable in joining a plurality of members. In general, however, the plastic materials have low surface energy and, hence, possesses poor hydrophilicity. In order to improve the hydrophilicity in plastic materials, more specifically to improve the hydrophilicity of the ink flow passage of the ink jet head, for example, Japanese Unexamined Patent Publication (Kokai) No. 60-24957 proposes the treatment of the surface of resin heads, such as polysulfone, polyethersulfone, AS, ABS, and many other resins, with a potassium chromate/sulfuric acid chemical, ultraviolet light, plasma, corona discharge, electron beam, or flame to activate the surface of the head. The activation of the surface of the head in this way can greatly improve the wettability as a result of introduction of a polar group, that is, permits a hydrophilic nature to be imparted. This prevents air bubbles from being left in the ink chamber at the time of filling of the ink into the ink chamber, and, even when air bubbles are formed, they can be smoothly removed.

The conventional treatment for imparting the hydrophilic nature can achieve satisfactory hydrophilicity in an early stage after the treatment. However, the persistence of the hydrophilicity is poor, and the hydrophilicity is remarkably deteriorated before or in the course of actual assembling of the head, or otherwise the hydrophilicity disappears during storage of the member after the treatment for imparting the hydrophilic nature for a long period of time. Specifically, in the conventional treatment for imparting the hydrophilic nature, the hydrophilicity of the ink flow passage in the head is deteriorated before the filling of an ink into the ink chamber, causing troubles associated with residual air bubbles.

In the ink jet printer, a problem of warpage of the member constituting the head is also important. The ink jet head generally comprises a piezoelectric device, a plurality of grooves provided on the top surface of the device, a lid provided on the top surface of the device so as to cover the grooves, and a nozzle plate having a nozzle hole provided on the front surface of the piezoelectric device. The grooves in the piezoelectric device constitute an ink chamber which is filled with an ink. The wall of the grooves filled with an ink is deformed upon driving of the piezoelectric device, and the ink compressed by the deformation is ejected as ink droplets towards a printing sheet through a nozzle hole in the nozzle sheet. A plastic material is, in many cases, used in a lid and a diaphragm, as the member for constituting this and other ink jet heads, and an ink head, in consideration of moldability, cost, and other required properties. When these members are mounted on a piezoelectric device, a high-temperature curing adhesive, which, after the application thereof, should be heated to a high temperature of 100° C. or above, for example, a thermosetting epoxy adhesive, is used in order to ensure high reliability with respect to joining between the piezoelectric device and the member. When this adhesive is used, heating to a high temperature and standing after that (the step of returning the temperature to room temperature) are required. During this period, large warpage is created in a member (lid), constituting a head, constructed of a plastic material. This is attributable to a difference in coefficient of thermal expansion among the material for the piezoelectric device, the material for the lid, and the material (usually a metal) for the nozzle sheet.

One means for reducing the warpage of the head-constituting member (lid) after bonding, which has been adopted in the art, is to incorporate a filler, for example, an inorganic powder, such as silicon dioxide (silica) or titanium oxide, into the plastic material. Use of a filler-containing plastic material in a member for constituting the head is effective in reducing the warpage of the member after bonding. Further, since the warpage is preferably as small as possible, the adhesive for bonding between the members is preferably one which does not require heating to a high temperature and subsequent standing, that is, a low-temperature curing adhesive (curable at a temperature below 100° C.). The low-temperature curing adhesive has a drawback in that the reliability is lower than that in the case of the high-temperature curing adhesive.

Therefore, when the low-temperature curing adhesive is used for bonding purposes, it is important that the adhesion of the adhesive to the bonding area of the member for constituting the head be high, that is, that the wettability of the surface of the member be high. Further, as described above, in the ink jet head, the surface of the member, which comes into contact with an ink, should have high wettability from the viewpoint of reliability in respect of print quality or the like. As described above, however, plastic materials, which are members for constituting the head, including those with a filler incorporated therein in current use, generally have low surface energy and, hence, possess unsatisfactory wettability.

Referring again to Japanese Unexamined Patent Publication (Kokai) No. 60-24957, as described above in detail, this publication proposes acid treatment of the surface of the resin head with a chemical based on potassium and sulfuric acid to improve the hydrophilicity of the ink flow passage in the ink jet head.

In the conventional method, wherein the surface of the head is treated with an acid to impart the hydrophilicity to the surface of the head, it is difficult to quantitatively estimate the hydrophilicity imparted by the acid treatment. In addition, the treatment capability of the acid solution, per se, used in the acid treatment unfavorably varies depending upon the amount and time of the acid solution used and other factors. Therefore, the control of the acid solution bath used is necessary in order to produce ink jet heads having uniform quality.

Further, as described above, since it is difficult to estimate the hydrophilicity, there is a possibility that the acid treatment for imparting the hydrophilic nature becomes unfavorably excessive and, as a result of excessive erosion, the dimension of the member per se can be adversely affected. A great change in the dimensions of the member as compared with that before the acid treatment gives rise to misregistration between members at the time of assembling, causative of the production of defective heads. On the other hand, when the acid treatment is unsatisfactory, the ink flow passage cannot be satisfactorily hydrophilized. As described above, this raises a trouble derived from remaining of air bubbles. Therefore, in imparting hydrophilicity to the member for constituting the head by acid treatment, in the step of acid treatment, optimal conditions should be selected, and the treatment should be regulated.

### DISCLOSURE OF THE INVENTION

An object of the present invention is to solve the above problems of the prior art, to impart good hydrophilicity to an ink flow passage in an ink jet head, and, at the same time, to maintain the good hydrophilicity for a long period of time, thereby providing an ink jet head capable of ensuring high print quality for a long period of time.

Another object of the present invention is to enable strong bonding between members in joining of a member, for constituting a head, comprising a plastic material to another member made of the same or a dissimilar material to assemble a head.

Still another object of the present invention is to solve a problem associated with warpage of a member, for constituting a head, comprising a plastic material and, at the same time, to improve the wettability of the surface of the member and to improve the persistence of the improved wettability.

A further object of the present invention is to ensure stable hydrophilicity of an ink flow passage of an ink jet head and, at the same time, to prevent a failure of assembly derived from poor dimensional accuracy in the assembly of a head from a member for constituting a head.

A still further object of the present invention is to provide a process for preparing the above improved ink jet head.

These and other objects of the present invention will be easily understood from the following detailed description. As is apparent from the following description, the term “hydrophilicity” used herein is synonymous with the term “wettability.”

According to one aspect of the present invention, there is provided an ink jet head, for use in an ink jet recording apparatus, comprising an ink chamber, at least part of a member constituting the ink chamber being made of a plastic material having a surface possessing hydrophilic nature imparted by surface treatment, for introducing a polar group, selected from the group consisting of acid treatment, preferably surface treatment with a mixed solution composed of sulfuric acid and aqueous hydrogen peroxide, ultraviolet light-ozone irradiation, and oxygen plasma treatment.

According to another aspect of the present invention, there is provided an ink jet head, for use in an ink jet recording apparatus, comprising an ink chamber, at least part of a member constituting the ink chamber being made of a filler-containing plastic material having a surface possessing hydrophilic nature imparted by acid treatment, preferably surface treatment with a mixed solution composed of sulfuric acid and aqueous hydrogen peroxide.

According to still another aspect of the present invention, there is provided an ink jet head, for use in an ink jet recording apparatus, comprising an ink chamber, at least part of a member constituting the ink chamber being made of a plastic material, wherein the plastic material has a surface possessing hydrophilic nature imparted by acid treatment, preferably surface treatment with a mixed solution composed of sulfuric acid and aqueous hydrogen peroxide and wherein in the treatment of the surface of the plastic material with an acid, the amount of the plastic material eluted by the acid treatment is quantitatively determined to optimally impart the hydrophilic nature to the surface of the plastic material.

According to a further aspect of the present invention, there is provided an ink jet head, for use in an ink jet recording apparatus, comprising an ink chamber, at least part of a member constituting the ink chamber being made of a plastic material, wherein the plastic material has a surface possessing a hydrophilic nature imparted, before the construction of the ink chamber, by acid treatment, preferably surface treatment with a mixed solution composed of sulfuric acid and aqueous hydrogen peroxide and wherein, after the construction of the ink chamber, an additional hydrophilic nature has been imparted to the surface of the plastic material by treatment with an alkali.

According to a still further aspect of the present invention, there is provided a process for producing an ink jet head for an ink jet recording apparatus, comprising constructing at least part of an ink chamber, of the head, out of a plastic material and subjecting the surface of the plastic material to surface treatment, for introducing a polar group, selected from the group consisting of acid treatment, ultraviolet light-ozone irradiation, and oxygen plasma treatment, thereby imparting a hydrophilic nature to the surface of the plastic material.

### BRIEF DESCRIPTION OF THE DRAWINGS

The present invention will be described in more detail with reference to the accompanying drawings in which:

FIG. 1 is a cross-sectional view showing one preferred embodiment of the construction of the ink jet head according to the present invention;

FIG. 2 is a typical diagram illustrating the effect attained by acid treatment of the surface of a plastic member according to the present invention;

FIG. 3 is a typical diagram illustrating the effect attained by alkali treatment of the surface of a plastic member according to the present invention;

FIG. 4 is a typical diagram illustrating the measurement of a contact angle used for evaluating a high level of hydrophilicity attained by the present invention;

FIG. 5 is an electron photomicrograph (magnification: 5000 times) showing the surface state of a filler-containing plastic member before and after acid treatment; and

FIG. 6 is a graph showing the relationship between the time of immersion of an epoxy resin in a sulfo-peroxide solution and the contact angle of the epoxy resin with pure water and the loss in thickness of the epoxy resin.

### BEST MODE FOR CARRYING OUT THE INVENTION

One aspect of the present invention provides an ink jet head, for use in an ink jet recording apparatus, comprising an ink chamber, at least part of a member constituting the ink chamber being made of a plastic material having a surface possessing a hydrophilic nature imparted by surface treatment, for introducing a polar group, selected from the group consisting of acid treatment, ultraviolet light-ozone irradiation, and oxygen plasma treatment.

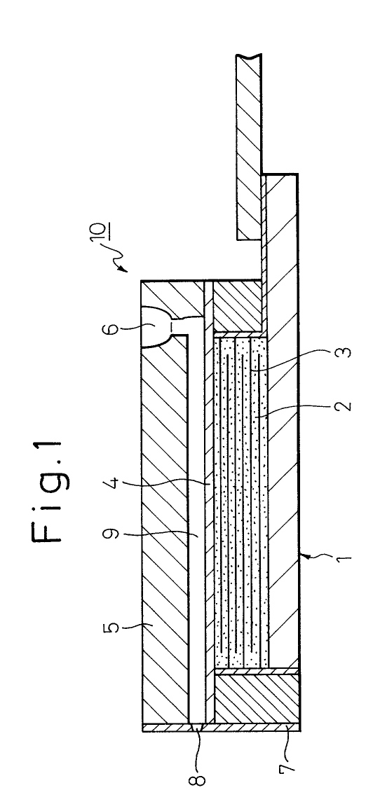

In the practice of the present invention, ink jet head bodies having various constructions, which are commonly used in the art, either per se or after modification, may be used as the ink jet head body. One preferred embodiment of the ink jet head usable in the practice of the present invention is shown in FIG. 1 with reference to which the present invention will be described below. In the embodiment shown in the drawing, an ink jet head 10 comprises: a substrate (also called “base”) 1 constituting the bottom of the head; a piezoelectric device (a piezo device) 2 provided above the substrate 1 and drivable, as required, by means of a built-in electrode sheet 3; a diaphragm 4 which, upon deformation of the piezoelectric device 2, can transfer a pressure wave to an ink chamber (an ink flow passage) 9; a lid 5 which constitutes the top of the head 10 and, together with the diaphragm 4 and other members, constitutes the ink chamber 9; an ink feed opening 6 provided in the lid 5; and a nozzle sheet 7 located on the front side (recording medium side) of the head 10 and provided with an ink jet nozzle 8. The nozzle 8 generally has a structure comprising a plurality of nozzles which have been arranged in a row. If necessary, the plurality of nozzles may be arranged in a plurality of rows from the viewpoint of improving the jetting efficiency. The term “member for constituting an ink chamber” used herein refers to a member, for constituting an ink chamber 9, i.e., a member having a surface at least part of which comes into contact with an ink, among the substrate 1, the piezoelectric device 2, the diaphragm 4, the lid 5, the nozzle sheet 8 and other members.

Ejection of an ink from the ink jet head 10 shown in the drawing toward a recording medium (not shown) is performed as follows. At the outset, energization of the electrode sheet 3 permits a voltage to be applied to the piezoelectric device 2 adjacent to the electrode sheet 3, creating expansion of the device. The expanded piezoelectric device 2 lifts the diaphragm 4 disposed above and so as to be adjacent to the piezoelectric device 2. The ink chamber 9 undergoes volume shrinkage (a pressure wave) due to lifting of the diaphragm 4. This permits the ink within the ink chamber 9 to be ejected as droplets through the nozzle 8, a sole outlet of the ink chamber, toward a recording medium. In this column, the practice of the present invention is described particularly with reference to a charge control type recording system utilizing a piezoelectric device. However, it is a matter of course that use of other systems, for example, bubble jet and other systems, can offer the same favorable effects.

The above members for constituting the ink jet head 10 may be constructed of various materials according to features of the head and other factors. For example, the substrate 1, the lid 5, and other members constituting a casing of the head may be constructed of preferably various plastic materials. Suitable plastic materials include, but are not limited to, acrylic resin, epoxy resin, polyethylene, polypropylene, polyester, polyacetal, polycarbonate, polyamide, polyimide, polystyrene, styrene/butadiene resin, acrylonitrile/butadiene/styrene (ABS) resin, ethylene-propylene rubber, polymethylpentene, polyphenylene sulfide, polyether ether ketone, and liquid crystalline polymer. These plastic materials may be used either alone or in combination of two or more. Further, different plastic materials may be used in respective members. Otherwise, the plastic material may be used in combination with other material(s), for example, metallic materials and alloy materials, for example, steel, stainless steel, nickel, and alloys thereof, ceramic materials, for example, alumina and zirconia, and the like.

Further, in order to enhance the strength or to prevent deformation such as warpage, the above plastic materials, if necessary and preferably, may comprise an organic or inorganic filler. Examples of organic and inorganic filling agents (fillers) usable herein include silica, carbon black, titanium oxide, graphite, molybdenum sulfide, fluororesin, clay, talc, a salt of silicic acid, and a salt of carbonic acid. These fillers may be used either alone or in combination of two or more. In use, they are generally homogeneously dispersed as a powder or a flake in the plastic material constituting the member. Although the amount of the filler added may widely vary depending upon the contemplated effect and the filler used, it is generally in the range from about 20 to 80% by weight based on the whole amount of the plastic material.

The piezoelectric device 2 may be constructed of a piezoelectric material commonly used in the art, for example, lead titanate zirconate (PZT). The electrode sheet 3 embedded in the piezoelectric device 2 may be constructed of a material, such as gold, embedded at the time of molding of the piezoelectric device by lamination or the like. The diaphragm 4 may be generally constructed of a diaphragm comprising a metallic material, such as nickel. The nozzle sheet 7 may be constructed of, for example, a metallic material, such as stainless steel or nickel, or other material in consideration of the formation of a nozzle 8.

In the ink jet head according to the present invention, at least part of the material, made of a plastic material, among the members constituting the ink chamber is treated for introducing a polar group so as to have a hydrophilic surface, in other words, so as to have good wettability by a water-base ink. Surface treatment methods which may be advantageously used in the practice of the present invention include acid treatment, ultraviolet-ozone (UV-O₃) irradiation, and oxygen (O₂) plasma treatment. When the surface of the plastic member has hydrophilic nature imparted by the above treatment, the strength of bonding between members in joining between members or between a plastic member and other member with the aid of an adhesive can be significantly improved. Further, a problem, such as peeling during use of the members after bonding, does not occur. Therefore, in the present invention, a low-temperature curing adhesive, use of which has been avoided in the prior art due to its low reliability, can be advantageously used without any problem. Further, in the ink chamber of the head, the plastic member surrounding the ink chamber has good hydrophilicity, realizing very smooth flow of an ink in the ink flow passage. Therefore, none of problems involved in the conventional ink jet head, such as unstable ejection of ink droplets and clogging of the nozzle, occur. Further, during the filling of an ink, troublesome supply of the ink into the ink chamber, due to the poor wettability of the member can be avoided and therefore so-called “dropouts” can be prevented. Furthermore, air bubbles are less likely to be created in the ink flow passage at the time of filling of an ink and, even though air bubbles are created, they can be easily removed by suction of the ink. Thus, ejection of ink droplets with undesired trajectories can be effectively prevented.

The above surface treatment for the plastic member may be performed in various stages in the production of an ink jet head, that is, before, in the course of, or after the construction of the ink chamber of the head. Preferably, the surface of the member for constituting the ink chamber may be treated in a stage before the construction of an ink chamber from the member. Further, according to one preferred embodiment of the present invention, the surface treatment is first performed as a first surface treatment in a stage before the construction of the ink chamber and then as a second surface treatment after the construction of the ink chamber and before use of the head. The first and the second surface treatment may be the same or different. As described below, however, use of a combination of acid treatment as the first surface treatment with alkali treatment as the second surface treatment is preferred.

Preferably, the acid treatment of the plastic member is carried out by jetting an acid for acid treatment onto the surface of the plastic member or by immersing the plastic member in a bath of an acid for the acid treatment. Regarding the acid for the acid treatment, since most plastic materials are resistant to general acids, preferred is an acid having very high oxidizing power which can defeat the acid resistance. A particularly preferred acid is an acid which has high oxidizing power even at room temperature or a low temperature and, when applied onto the surface of the plastic member, can break the molecular structure of the surface of the member and introduce a polar group, especially a mixed solution composed of sulfuric acid and aqueous hydrogen peroxide (which, as used in the art, will be hereinafter referred to as “sulfo-peroxide solution”). In the preparation of the sulfo-peroxide solution, sulfuric acid and aqueous hydrogen peroxide may be used in various respective concentrations. Preferably, the concentration is one equal to or around 96% for sulfuric acid and one equal to or around 30% for aqueous hydrogen peroxide, from the viewpoint of the concentration of the reagent, availability and the like. In the sulfo-peroxide solution, the mixing ratio (volume ratio) of sulfuric acid to aqueous hydrogen peroxide may widely vary depending upon factors, such as the desired degree of hydrophilization and the kind of the plastic member to be treated. It, however, is preferably in the range of from about 2:1 to 10:1. For example, when the mixing ratio (volume ratio) of sulfuric acid to aqueous hydrogen peroxide in the sulfo-peroxide solution is 8:1, the content of sulfuric acid in the sulfo-peroxide solution is 85%.

In this connection, it should be noted that sole use of concentrated sulfuric acid or concentrated nitric acid also permits a polar group to be introduced into the surface of the plastic member. In this case, however, satisfactory effect cannot be expected at room temperature, and heating to a high temperature of 100° C. or above is necessary, resulting in poor workability. Further, heating to the high temperature disadvantageously requires special equipment for heating.

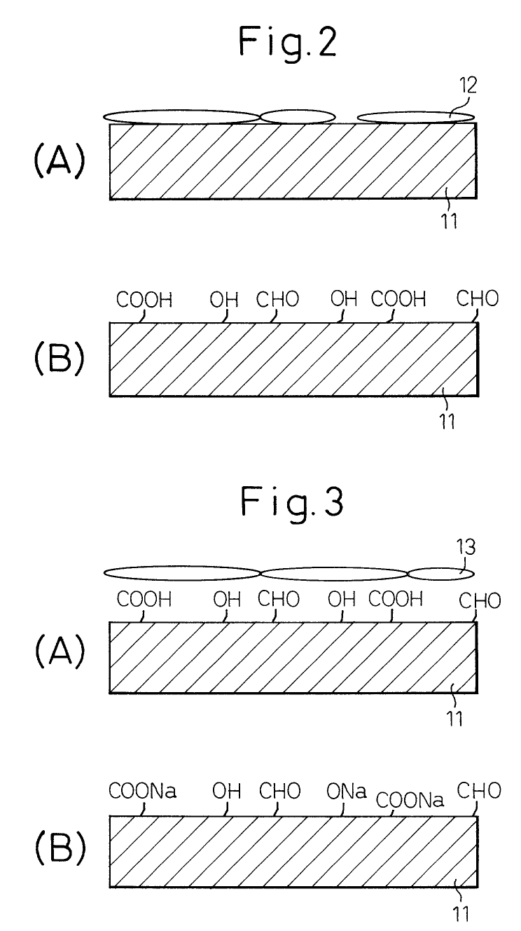

The effect attained by the treatment of the surface of the plastic member with the sulfo-peroxide solution will be easily understood from a typical view shown in FIG. 2. Here, reference will be made to an embodiment where polystyrene is used as the plastic member, a mixed solution composed of 96% sulfuric acid and 30% aqueous hydrogen peroxide in a mixing ratio (volume ratio) of 8:1 is used as the sulfo-peroxide solution, and the plastic member is immersed in the sulfo-peroxide solution at room temperature (20° C.) for 5 min.

As shown in FIG. 2(A), a plastic member 11 for an ink chamber of an ink jet head has soil 12 on its surface. The soil 12 includes, for example, fats and oils deposited during molding of the plastic member, a plastic material powder, dust, and others. These soils cannot be satisfactorily removed by conventional washing with water and other washing methods. Therefore, the surface of the plastic member 11 after the conventional washing remains hydrophobic even though soil could be removed.

By contrast, as shown in FIG. 2(B), the surface treatment with the sulfo-peroxide solution according to the present invention permits soil to be fully removed from the surface of the plastic member 11 and, at the same time, the surface to be rendered hydrophilic. Specifically, as a result of the surface treatment, the molecular structure of the surface of the plastic member 11 is broken, and, as shown in the drawing, a polar group, such as a carboxyl group (—COOH), a hydroxyl group (—OH), or an aldehyde group (—CHO), is introduced into the broken site. These polar groups form a weak bond with a water molecule through an electrostatic interaction or a hydrogen bond. Therefore, it is hydrophilic, well wetted by an ink, and, when the member is joined with the aid of an adhesive, can enhance the adhesive strength.

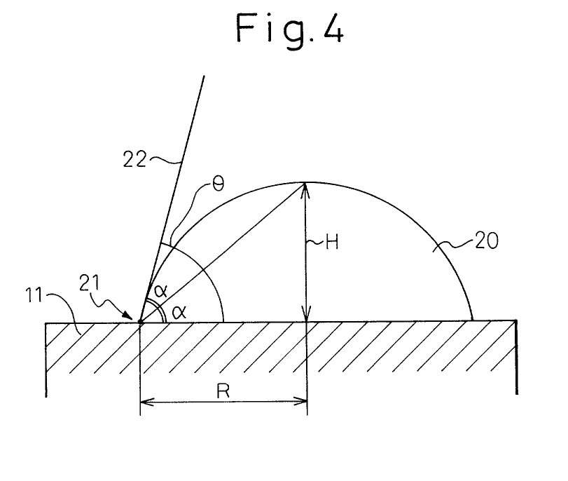

In fact, this surface treatment results in markedly improved wettability of the surface of the plastic member 11 by a water-base ink. This effect is apparent, for example, by reference to the contact angle with pure water which is a general measure of the wettability. The contact angle of the surface of the plastic member 11 with pure water before the hydrophilization shown in FIG. 2(A) was 80°, whereas the surface of the plastic member 11 after the hydrophilization shown in FIG. 2(B) had a contact angle thereof with pure water reduced to 15°. In this case, the contact angle was measured as shown in FIG. 4 according to the definition specified in JIS K6800. Specifically, a plastic member 11 is fixed so that the surface thereof is horizontal. Pure water 20 is dropped on the surface, and, immediately after the dropping of the pure water, an angle 21 of a tangential line 22 on a vertical section of a water droplet to the plastic member 11 was determined as a contact angle θ.

tan α=H/R

contact angle θ=2×α

In this case, H represents the height of the pure water 20 from the face in contact with the plastic member 11, and R represents the radius of the pure water 20 in the face in contact with the plastic member 11.

In the practice of the present invention, similarly, use of ultraviolet-ozone irradiation or oxygen plasma treatment instead of the acid treatment results in the contemplated hydrophilization. For example, ultraviolet-ozone irradiation of the plastic member can be advantageously performed by placing a plastic member in a commercially available UV dry processor and irradiating the plastic member with ultraviolet light over a predetermined period of time in the presence of a generated ozone gas. The oxygen plasma treatment can be advantageously performed by placing a plastic member as a target in a plasma treatment apparatus and irradiating the target with oxygen plasma. Conditions for each treatment may be selected according to a conventional method.

As described above, regarding the hydrophilization treatment according to the present invention, mere acid treatment or other surface treatment can offer satisfactory effect. Further, according to the finding of the present inventors, the hydrophilicity of the surface of the plastic member can be further improved by combining the surface treatment for introducing a polar group with additional practice of alkali treatment for the regeneration of the hydrophilicity. Preferably, the two-stage surface treatment can be advantageously performed in such a manner that, after acid treatment particularly with a sulfo-peroxide solution (first surface treatment) before the construction of an ink chamber from the plastic member, the hydrophilic nature is additionally imparted by performing alkali treatment (second surface treatment) of the surface (exposed surface) of the plastic member constituting the ink chamber after the construction of the ink chamber (i.e., either immediately after the construction or a predetermined period of time after the construction) or before use of the head.

In the two-stage surface treatment, the first surface treatment may be performed as described above. The purpose of the second surface treatment is particularly to remove soil derived from a gas emitted from a residue, such as an adhesive newly deposited in the construction of an ink chamber from the plastic member or soil derived from other sources and to activate the polar group introduced into the surface of the plastic member and, in some cases, to introduce a new polar group. Preferably, the second surface treatment is performed with an alkali solution having high alkalinity. Suitable alkali solutions include, but are not limited to, for example, a sodium hydroxide solution, a potassium hydroxide solution, a diethanolamine solution, a triethanolamine solution, and a triethylamine solution. For example, when a sodium hydroxide solution is used as the alkali solution, a 1 to 20 wt % sodium hydroxide solution may be advantageously used. Preferably, the alkali treatment can be effectively performed by dipping an assembled ink jet head in a bath of a selected alkali solution or by conducting a selected alkali solution through an ink chamber of an assembled ink jet head.

The effect attained by the treatment (second surface treatment) of the surface of the plastic member within the head with a sodium hydroxide solution as the alkali solution can be understood from FIG. 3 (a typical view). Here, reference will be made to an embodiment where a high-temperature curing epoxy adhesive is used in assembling a head from a plastic member, heating is performed at 130° C. for one hr to cure the adhesive and the assembled head is immersed in a bath of a 20 wt % aqueous sodium hydroxide solution at room temperature (20° C.) for 30 min.

As shown in FIG. 3(A), despite that the plastic member 11 constituting the ink chamber of the ink jet head has been hydrophilized by the hydrophilization treatment before the construction of the ink chamber (see FIG. 2(B), the surface has new soil 13 derived from an adhesive used in the stage of assembling the head. The soil 12 deposited so as to cover the hydrophilic layer of the member 11 are derived mainly from a gas produced by vaporization of a component of an adhesive during heating at a high temperature for a long period of time for curing the adhesive used for joining between members at the time of construction of the head or derived from other organic materials. These soils deteriorates the hydrophilicity of the ink flow passage and cannot be satisfactorily removed by conventional washing with water and other washing methods.

On the other hand, as shown in FIG. 3(B), the second surface treatment with an alkali solution according to the present invention can remove the soils from the surface of the plastic member 11 to clean the surface of the plastic member 11, again developing the hydrophilic nature of the surface of the plastic member 11. In particular, in the second surface treatment, as a result of the surface treatment with an alkali, at least part of a hydrogen ion of the polar group introduced into the surface of the plastic member 11 is replaced with a positive ion (Na⁺ or the like) in the alkali solution. Specifically, the carboxyl group is converted to—COONa, and the hydroxyl group is converted to—ONa. The positive ion, which has been introduced into the polar group in this way, has higher dissociability than the hydrogen ion and, hence, is more hydrophilic. This can improve the hydrophilicity of the ink flow passage of the head as a completed form and, at the same time, can maintain the good hydrophilicity for a long period of time. Therefore, the ink jet head according to the present invention is less likely to create air bubbles within the ink flow passage at the time of filling of the ink into the ink chamber and, even though air bubbles are created, permits the air bubbles to be easily removed by suction of the ink.

The above soil derived from the use of an adhesive can be deposited also in a plastic member which has not been subjected to the first surface treatment of the present invention. In this case, even though the soil could be removed by the second surface treatment according to the present invention, the surface of the member remains hydrophobic.

According to another preferred embodiment of the present invention, the ink jet head comprises a member comprising a filler-containing plastic material (the term “member” used herein referring to various members constituting the head without limitation to the member constituting the ink chamber) having a surface which has been subjected to the above acid treatment according to the present invention.

As described above, use of the filler-containing plastic material as a member for constituting the ink chamber results in reduced warpage after bonding of the member. Further, use of a low-temperature curing adhesive curable generally at a temperature below 100° C. instead of the high-temperature curing adhesive is also effective for reducing the warpage. The low-temperature curing adhesive, however, is disadvantageous in that the reliability regarding the adhesive power is not high. High adhesion of the adhesive to the surface, to be bonded, of the member, that is, high wettability of the surface, is important from the viewpoint of ensuring high reliability. The high wettability is important also from the viewpoint of improving the reliability in respect of print quality and the like. As described above, however, since the plastic material generally has low surface energy, it is less likely to be wettable by a liquid and, hence, does not have satisfactory wettability.

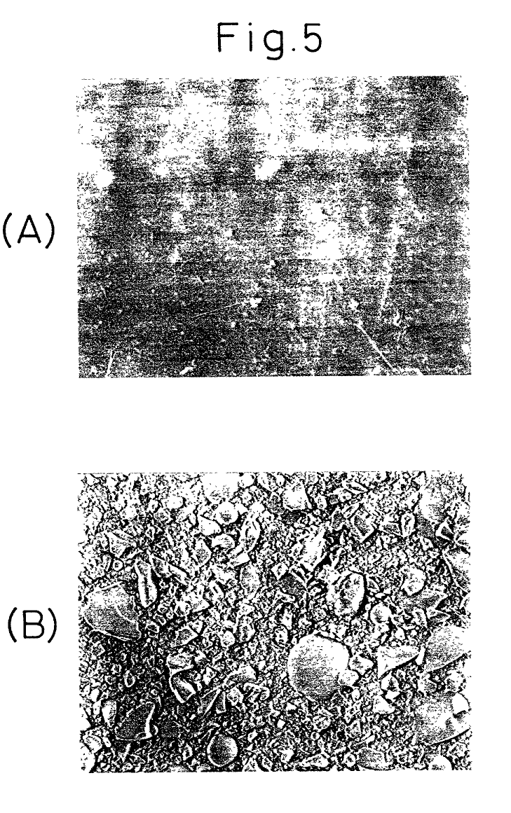

Unexpectedly, however, when the member comprising a filler-containing plastic material is subjected to predetermined acid treatment with a sulfo-peroxide solution according to the present invention, the wettability of the surface of the plastic member could be markedly improved and the improved wettability could be maintained for a long period of time, despite the fact that the acid treatment was simply carried out. The effect of improving the wettability could be more easily understood from the following description with reference to FIG. 5 showing the state of the plastic member before and after the treatment with a sulfo-peroxide solution.

As is apparent from an electron photomicrograph (×5000) shown in FIG. 5(A), the filler-containing plastic member has a substantially smooth surface. This plastic member is a plastic with a filler (an inorganic powder) incorporated therein as used in working examples described below, which is an injection molded product of a thermosetting resin commercially available from Mitsui Petrochemical Industries, Ltd. under the trade name “EPOX”.

Upon the treatment of the surface of the filler-containing plastic member with a sulfo-peroxide solution according to the present invention, the highly acidic nature of the sulfo-peroxide solution used causes the plastic member in its surface to be broken, and, as is apparent from an electron photomicrograph (×5000) shown in FIG. 5(B), the filler, the presence of which has not been clear before the treatment, is exposed on the surface of the member. The exposed filler and different sizes, i.e., large and small sizes, of the filler create a structure having irregularities in the surface of the member. The magnitude of irregularities may widely vary depending upon the plastic member used, sulfo-peroxide solution, treatment conditions, desired results and the like. In general, however, it is about 2 to 5 μm or more as calculated from the peak height and the valley depth. The creation of the surface structure having irregularities increases the area of the surface of the plastic member, resulting in improved surface energy. Improved surface energy increases the hydrophilicity of the surface of the member. Further, since the filler per se has high hydrophilicity, part of the filler is exposed on the surface of the member. This additionally increases the hydrophilicity.

When the filler is an oxide, oxygen atoms present on the exposed surface of the filler are hydrated with moisture in the atmosphere to form a hydroxyl group. Further, a hydroxyl group or a carboxyl group is formed on the surface of the plastic which has been broken by the sulfo-peroxide solution. The formation of the polar group, such as a hydroxyl group or a carboxyl group, results in increased hydrophilicity of the surface of the plastic member, facilitating the deposition of a highly polar liquid (such as water, a water-base ink, or an epoxy adhesive) onto the surface of the member. That is, the synergistic effect, of the increased surface energy and the formation of a polar group, such as a hydroxyl group or a carboxyl group, attained by the treatment of the filler-containing plastic member with a sulfo-peroxide solution can markedly improve the wettability of the surface of the member. The method for treatment with a sulfo-peroxide solution referred herein is not particularly limited, and, as described above, preferred methods include jetting the sulfo-peroxide solution onto the plastic member and dipping of the plastic member in a bath of the sulfo-peroxide solution.

Further, the treatment with a sulfo-peroxide solution followed by the alkali treatment, which has been described above in detail, results in further improved wettability. Specifically, the hydrophilicity can be increased as a result of replacement of H⁺ as a polar group with Na⁺ or the like having higher associability.

In the practice of the present invention, preferably, in the acid treatment of the surface of the plastic material as a member for constituting the ink chamber to conduct etching, the amount of the plastic material eluted by the acid treatment is quantitatively determined to optimally impart the hydrophilic nature to the surface of the plastic material. Specifically, when the surface of the plastic material is roughened by etching with an acid to impart hydrophilic nature to the surface, quantitative determination of the amount of the plastic material eluted by the etching to optimize the roughening is preferred. In this case, the optimal degree of roughening of the surface of the plastic material may widely vary depending upon various factors, for example, desired results, kind and properties of the member used, and conditions for acid treatment. For example, a roughness of not less than 0.5 μm in terms of the depth of etching by acid treatment may be mentioned as one preferred target. Plastic materials usable herein include those with a filler internally incorporated therein. Preferably, the acid treatment is performed with a sulfo-peroxide solution. Subsequent to the acid treatment, alkali treatment may be performed from the viewpoint of further hydrophilizing the surface of the member.

In this preferred embodiment of the present invention, acid treatment is first performed on a component level. Specifically, the plastic material as the member for constituting the ink chamber is immersed in an acid solution, or alternatively, sprayed with an acid material to form a polar group, thereby hydrophilizing the surface of the material. Imparting the hydrophilic nature to the surface of the material results in increased strength of bonding between the components or between the component and other member(s) with the aid of an adhesive. In this case, the amount of the plastic material eluted by the acid treatment is measured, and the loss in thickness of the material caused by etching is estimated from the amount of the eluted plastic material and the surface area of the member for constituting the ink chamber, permitting the dimension of components to be stably controlled.

When a plastic material containing a filler, such as an inorganic powder, is used in the member for constituting the ink chamber, the acid treatment results in the creation of a structure having fine irregularities in the surface of the member, because the filler is not attacked by the acid, increasing the bonding area, which leads to further improved adhesion. In this case, the amount of the eluted plastic material for constituting the ink chamber is determined to suitably control the surface roughness of the member for constituting the ink chamber.

Thus, the process for producing an ink jet head, involving the above step of determining the amount of the eluted plastic material according to the present invention, can provide an ink jet head having a combination of hydrophilic nature with dimensional stability. That is, in the ink jet head, air bubbles are less likely to be created in the ink flow passage at the time of filling of an ink into the ink chamber and, even though they are created, can be easily removed by ink suction operation. Further, there is no change in dimension derived from the acid treatment, and, hence, unlike the prior art, no failure of assembly occurs.

In the practice of the present invention, the amount of the plastic material eluted by the acid treatment can be quantitatively determined by using a technique commonly used in the field of analytical chemistry without modification or after suitable modification. For example, the mass of the plastic member may be measured before and after the acid treatment to determine a change in mass. The magnitude of the change in mass is the amount of the eluted plastic material. The amount of the eluted plastic member is then divided by the surface area of the plastic material to determine the amount, per unit area, of the eluted plastic material. After the determination of the amount, per unit area, of the eluted plastic material, the loss in thickness of the member caused by the etching can be estimated from the specific gravity and content of the plastic material. If necessary, the quantitative determination of the eluted plastic material may be, if necessary, performed by other methods.

Plastic materials, acid treatment, alkali treatment and the like, which may be advantageously used in the present invention, have been described above in detail. Therefore, description of these matters is not repeated here.

According to another aspect of the present invention, there is provided a process for producing an ink jet head for an ink jet recording apparatus, comprising constructing at least part of an ink chamber, of the head, out of a plastic material and subjecting the surface of the plastic material to surface treatment, for introducing a polar group, selected from the group consisting of acid treatment, ultraviolet light-ozone irradiation, and oxygen plasma treatment, before, in the course of, or after the construction of the ink chamber, thereby imparting hydrophilic nature to the surface of the plastic member.

As can be understood from the above description, the process for producing an ink jet head according to the present invention can be advantageously practice in various embodiments which are mainly listed as follows. However, it should be understood that the process according to the present invention is not limited to the following embodiments only.

1. The process wherein the acid treatment is performed by applying a mixed solution composed of sulfuric acid and aqueous hydrogen peroxide (sulfo-peroxide solution) onto the plastic member.

2. The process wherein the acid treatment is performed by jetting the sulfo-peroxide solution onto the plastic member or by immersing the plastic member in the sulfo-peroxide solution.

3. The process wherein the mixing ratio (volume ratio) of sulfuric acid to aqueous hydrogen peroxide in the sulfo-peroxide solution is 2:1 to 10:1.

4. The process wherein the surface treatment for introducing a polar group is performed before constructing the ink chamber from the plastic member and, after the construction of the ink chamber, an additional hydrophilic nature is imparted to the surface of the plastic member by treatment with an alkali.

5. The process wherein the alkali treatment is alkali cleaning of the interior of the ink chamber with a 1 to 20 wt % sodium hydroxide solution.

6. The process wherein the plastic member wherein contains a filler incorporated therein.

7. The process wherein, in the treatment of the surface of the plastic material with an acid, the amount of the plastic material eluted by the acid treatment is quantitatively determined to optimally impart the hydrophilic nature to the surface of the plastic material.

In the practice of the present invention, processes, such as acid treatment and alkali treatment, may be carried out according to methods which have been described above and will be described in more detail in the following examples. Other processes may be carried out according to methods commonly used in the art.

### EXAMPLES

The present invention will be described in more detail with reference to the following examples. It should be understood that the present invention is not limited to these examples only. In the following examples, a change in wettability of plastic members was evaluated based on a change in contact angle θ of pure water on the surface of the members. The change in contact angle θ was measured according to the procedure, set forth in JIS K6800, which has been described above with reference to FIG. 4.

### Example 1

### Treatment of Polystyrene Member with Sulfo-peroxide Solution

A member having a form and a dimension corresponding to a lid of an ink jet head shown in FIG. 1 was molded using a polystyrene resin. The contact angle θ of the polystyrene member with pure water was 80°.

Separately, sulfuric acid (96%) (manufactured by Tokuyama Corporation) for use in electronic industries and aqueous hydrogen peroxide (30%) (manufactured by Santoku Chemical Industries Co., Ltd.) for use in electronic industries were mixed together in a volume ratio of 8:1 to prepare a sulfo-peroxide solution. The molded polystyrene member was then immersed in a bath of the sulfo-peroxide solution, and, in this state, the bath was kept at a temperature of 19° C. for 20 min. The treated polystyrene member was taken out of the sulfo-peroxide solution bath, washed with pure water, and then dried. The contact angle θ of the polystyrene member, after treatment with the sulfo-peroxide solution, with pure water was 15°, indicating that the treatment of the member with a sulfo-peroxide solution according to the present invention resulted in markedly improved wettability of the surface of the member.

The polystyrene member was used for the preparation of an ink jet head shown in FIG. 1. As a result, the polystyrene member, by virtue of improved wettability of the surface thereof, had good adhesion, through an adhesive, to other members.

### Example 2

### Treatment of Polystyrene Member with Sulfo-peroxide solution+Treatment with Alkali

The procedure of Example 1 was repeated, except that, in order to simulate the deposition of a contaminant onto the surface of the polystyrene member, the polystyrene member treated with the sulfo-peroxide solution was allowed to stand in air at room temperature (19° C.) for 24 hr. After the standing in air, the member unfavorably had an increased contact angle θ thereof with pure water, that is, the contact angle θ, which was 15° before the standing, was increased to 45°after the standing. This phenomenon is understood to be derived from the deposition of a contaminant in air on the surface of the member during the standing in air.

Subsequently, a 20 wt % aqueous sodium hydroxide solution was prepared from first-grade sodium hydroxide (93%) (manufactured by Kokusan Chemical Works Ltd.). The polystyrene member, which had been allowed to stand in air, was immersed in a bath of the aqueous sodium hydroxide solution, and, in this state, the bath was kept at 20° C. for 30 min. Thereafter, the alkali-treated polystyrene member was taken out of the bath, washed with pure water, and then dried. The contact angle θ of the alkali-treated polystyrene member with pure water was measured and found to be 21°, indicating that the treatment of the member with an alkali according to the present invention permitted the wettability of the surface of the member, which had been unfavorably deteriorated to 45° in terms of the contact angle of the member with pure water, to be markedly improved.

Further, the alkali-treated polystyrene member was then allowed to stand in air at room temperature (19° C.) for 24 hr in the same manner as described above. As a result, it was surprisingly found that the standing in air resulted in only a slight increase in contact angle θ of the polystyrene member with pure water, that is, from 21° before the standing to 30° after the standing, suggesting that the alkali treatment in combination with the treatment with the sulfo-peroxide solution is more effective in imparting the persistence of hydrophilicity to the polystyrene member than mere hydrophilization by treatment with the sulfo-peroxide solution alone.

### Example 3

### Treatment of Polystyrene Member with Sulfo-peroxide Solution

The procedure of Example 1 was repeated, except that, instead of immersing the polystyrene member in the bath of a sulfo-peroxide solution at 19° C. for 20 min, the polystyrene member was immersed in the bath at that temperature (19° C.) for 5 min and 10 min, washed with pure water, and then dried. The results of the measurement of the contact angle θ of the polystyrene members, after the above treatment with sulfo-peroxide solution, with pure water, together with the results of the Example 1, are summarized in the following Table 1.

Simulation of the deposition of a contaminant onto the surface of a polystyrene member was performed in the same manner as in Example 2, except that, instead of allowing the polystyrene member treated with a sulfo-peroxide solution to stand in air at room temperature (19° C.) for 24 hr (one day), the polystyrene member was allowed to stand at that temperature (room temperature, 19° C.) for 4, 7, and 8 days. The results of the measurement of the contact angle θ of the polystyrene members, after the standing in air, with pure water, together with the results of Example 1 and, for comparison, the results of the measurement of the contact angle θ of the polystyrene member, before the treatment with sulfo-peroxide solution, are summarized in the following Table 1.

TABLE 1
Contact angle θ (°) of polystyrene member with pure water

| | | Immersion in | Time of immersion | | |
|---|---|---|---|---|---|
| | | sulfo-peroxide | in sulfo-peroxide | | |
| Time of | | solution | solution (min) | | |
| standing in air | | Not done | 5 | 10 | 20 |
| 0 | (measured | 80° | 43° | 24° | 15° |
| | on the day) | | | | |
| 1 | day | 72° | — | 28° | 45° |
| 4 | days | 80° | 52° | 43° | 42° |
| 7 (8) | days | 80° | (54°) | 45° | 56° |

As is apparent from the results of Table 1, the treatment with a sulfo-peroxide solution according to the present invention is effective in improving the hydrophilicity of the polystyrene member, and, when the treated member is allowed to stand, the improved hydrophilicity is deteriorated.

### Example 4

### Treatment of Polystyrene Member with Sulfo-peroxide Solution+Treatment with Alkali

The procedure of Example 3 was repeated (excluding the case where the time for immersion in sulfo-peroxide solution was 5 min), and the procedure of Example 2 was repeated, except that the step of standing in air after the treatment with sulfo-peroxide was omitted because it was performed in Example 3.

Also in this example, in order to simulate the deposition of a contaminant onto the surface of the polystyrene member, the alkali-treated polystyrene member was allowed to stand in air at room temperature (19° C.). In this example, however, the time for standing of the alkali-treated polystyrene member in air was 24 hr (one day) and 7 days. The results of the measurement of the contact angle θ of the polystyrene members, after the standing in air, with pure water, together with the results of Example 2 and, for comparison, the results of the measurement of the contact angle θ of the polystyrene member, which had been subjected to the alkali treatment alone without performing the treatment with the sulfo-peroxide solution, are summarized in the following Table 2.

TABLE 2
Contact angle θ (°) of polystyrene member with pure water
[Treatment with sulfo-peroxide solution
followed by treatment with alkali*]

| | | Immersion in | Time of immersion | | |
|---|---|---|---|---|---|
| | | sulfo-peroxide | in sulfo-peroxide | | |
| Time of | | solution | solution (min) | | |
| standing in air | | Not done | 5 | 10 | 20 |
| 0 | (measured | 80° | — | 27° | 21° |
| | on the day) | | | | |
| 1 | day | 74° | — | 31° | 30° |
| 7 | days | 70° | — | 37° | 34° |

*The same as the alkali treatment in Example 2

As is apparent from the results shown in Table 2, even though the hydrophilicity of the polystyrene member, which has been improved by the treatment with a sulfo-peroxide solution, is deteriorated upon standing of the polystyrene member in air, subsequent alkali treatment according to the present invention can recover the hydrophilicity to the initial level. In this connection, it should be particularly noted that, in this example, the alkali treatment is more effective in imparting the persistence of hydrophilicity to the polystyrene member than the treatment with sulfo-peroxide solution.

### Example 5

### Treatment of Polyimide Member with Sulfo-peroxide Solution

A member having a form and a dimension corresponding to a lid of an ink jet head shown in FIG. 1 was molded using a polyimide resin. The contact angle θ of the polyimide member with pure water was 65°.

Separately, sulfuric acid (96%) (manufactured by Tokuyama Corporation) for use in electronic industries and aqueous hydrogen peroxide (30%) (manufactured by Santoku Chemical Industries Co., Ltd.) for use in electronic industries were mixed together in a volume ratio of 8:1 to prepare a sulfo-peroxide solution. The molded polyimide member was then immersed in a bath of the sulfo-peroxide solution, and, in this state, the bath was kept at a temperature of 20° C. for 5 min. The treated polyimide member was taken out of the sulfo-peroxide solution bath, washed with pure water, and then dried. The contact angle θ of the polyimide member, after the treatment with the sulfo-peroxide solution, with pure water was 55°, indicating that the treatment of the member with a sulfo-peroxide solution according to the present invention resulted in markedly improved wettability of the surface of the member.

The polyimide member was used for the preparation of an ink jet head shown in FIG. 1. As a result, the polyimide member, by virtue of improved wettability of the surface thereof, had good adhesion, through an adhesive, to other members.

### Example 6

### Treatment of Polyimide Member with Sulfo-peroxide Solution+Treatment with Alkali

The procedure of Example 5 was repeated. Subsequent to the treatment with the sulfide-peroxide solution, the polyimide member, which had been treated with the sulfo-peroxide solution, was immersed in a bath of a 20 wt % sodium hydroxide solution prepared from first-grade sodium hydroxide (93%) (manufactured by Kokusan Chemical Works Ltd.) and kept at 20° C. for 10 min. The alkali-treated polyimide member was taken out of the bath, washed with water, and then dried. The contact angle θ of the alkali-treated polyimide member with pure water was 10, suggesting that the alkali treatment of the member according to the present invention resulted in a further marked improvement in wettability of the surface of the member which had been improved by the treatment with the sulfo-peroxide solution to 55°.

Subsequently, in order to simulate the deposition of a contaminant derived from an adhesive onto the surface of the polyimide member, the polyimide member after the treatment with the sulfide-peroxide solution and the polyimide member after the treatment with the sulfide-peroxide solution and the treatment with the alkali were allowed to stand in an adhesive atmosphere. For this standing test, the polyimide members and a high-temperature epoxy adhesive (thermosetting epoxy adhesive, available from Taiyo Ink Mfg. Co., Ltd. under the trade name “S-40C”) were placed in an identical vessel, and the adhesive was then cured at 130° C. for one hr. After the standing test, the polyimide member (which had been treated with the sulfide-peroxide solution and the alkali) unfavorably had an increased contact angle θ thereof with pure water, that is, the contact angle θ, which was 10° before the standing, was increased to 69° after the standing. On the other hand, the polyimide member (which had been treated with the sulfide-peroxide solution alone) after the standing test also unfavorably had an increased contact angle θ thereof with pure water, that is, the contact angle θ, which was 55° before the standing, was increased to 68° after the standing. This demonstrates that a gas, emitted from the adhesive, adversely influenced the surface of the polyimide members, resulting in remarkably deteriorated hydrophilicity of the surface of the members.

Subsequently, the two polyimide members, which had been exposed to the adhesive atmosphere, were immersed in the same bath of a 20 wt % sodium hydroxide solution as prepared above, and, in this state, kept at 20° C. for 10 min. The alkali-treated polyimide members were taken out of the bath, washed with pure water, and then dried. For both the alkali-treated members, the contact angle θ thereof with pure water was 10°, indicating that the alkali treatment according to the present invention had markedly improved the wettability of the surface of the polyimide members which had been deteriorated, by the exposure to an adhesive atmosphere, respectively, to 69° and 68°.

### Example 7

### Treatment of Polyimide Member with UV-ozone

The procedure of Example 5 was repeated, except that UV-ozone treatment was adopted instead of the treatment with a sulfide-peroxide solution. The UV-ozone treatment was performed under the following conditions.

Device: UV dry processor, VUM-3333-A-00, manufactured by Orc Manufacturing Corporation

Conditions: irradiation with UV light for 10 min After the completion of the treatment, the treated polyimide member was taken out of the device, and the contact angle of the member was then measured. As a result, the contact angle θ between the polyimide member after the UV-ozone treatment and pure water was 30°, suggesting that the UV-ozone treatment according to the present invention resulted in improved wettability of the surface of the member.

The polyimide member thus prepared was used for the preparation of an ink jet head shown in the FIG. 1. As a result, the polyimide member, by virtue of improved wettability of the surface thereof, had good adhesion, through an adhesive, to other members.

### Example 8

### Treatment of Filler-containing Epoxy Resin Member with Sulfo-peroxide Solution

A member having a form and a dimension corresponding to a lid of an ink jet head shown in FIG. 1 was injection-molded using a filler(silicon dioxide)-containing thermosetting epoxy resin, EPOX (trade name), manufactured by Mitsui Petrochemical Industries, Ltd. The contact angle θ of the filler-containing epoxy member with pure water was measured and found to be 90°.

Separately, sulfuric acid (96%) (manufactured by Tokuyama Corporation) for use in electronic industries and aqueous hydrogen peroxide (30%) (manufactured by Santoku Chemical Industries Co., Ltd.) for use in electronic industries were mixed together in a volume ratio of 8:1 to prepare a sulfo-peroxide solution. The molded epoxy member was then immersed in a bath of the sulfo-peroxide solution, and, in this state, the bath was kept at 19° C. for 15 min. This resulted in exposure of the filler, incorporated into the epoxy member, onto the surface of the member. The treated epoxy member was taken out of the sulfo-peroxide solution bath, subjected to ultrasonic cleaning with pure water, and then dried by nitrogen blast. The epoxy member after the treatment with the sulfo-peroxide solution had a contact angle 0 with pure water of less than 10° (immediately after the treatment). The epoxy member, which had been treated with the sulfo-peroxide solution, was allowed to stand for 1 and 24 hr, and the contact angle θ of the member with pure water was measured again. As a result, the contact angle was still less than 10°, indicating that the treatment of the member with a sulfo-peroxide solution according to the present invention resulted in markedly improved wettability of the surface of the member, as well as in retention of the excellent wettability for a long period of time.

The epoxy resin member, with a filler incorporated therein, thus prepared was used for the preparation of an ink jet head shown in the FIG. 1. As a result, the polyimide member, by virtue of improved wettability of the surface thereof, had very good adhesion, through an epoxy adhesive, to other members.

### Example 9 (Comparative Example)

### Oxygen Plasma Treatment of Filler-containing Epoxy Resin Member

The procedure of Example 8 was repeated, except that oxygen plasma treatment was adopted instead of the treatment with a sulfide-peroxide solution. The oxygen plasma treatment was performed under plasma irradiation conditions of pressure 0.5 Torr, power 50 W, and irradiation time 2 min. After the completion of the treatment, the treated epoxy member was taken out of the device, and the contact angle of the member was then measured. As a result, the contact angle θ between the epoxy member after the oxygen plasma treatment and pure water was less than 10° (immediately after the treatment), 30° (after the standing for one hr), and 50° (after the standing for 24 hr). The results of the measurement show that the wettability remarkably deteriorates with the elapse of time although an improvement in wettability of the surface of the treated epoxy member in an early stage after the oxygen plasma treatment may be expected.

### Example 10

### Measurement of Surface Roughness

The procedure of Example 8 was repeated to investigate the change in surface roughness of a filler-containing epoxy resin member by the treatment with a sulfo-peroxide solution according to the present invention.

The surface roughness (Ra, arithmetic average roughness) was measured for three levels of treatment time, that is, 10, 20, and 30 min. TENCOR α Step 200 was used as a device for this measurement. The results are summarized in following Table 3.

TABLE 3

| | | | | |
|---|---|---|---|---|
| Treatment time (min) | 0 | 10 | 20 | 30 |
| Surface roughness (nm) | 40 | 63 | 102 | 134 |

From the results given in Table 3, it is apparent that a longer treatment time caused more significant exposure of the filler, resulting in larger surface roughness of the epoxy member.

### Example 11

### Treatment of Epoxy Member with Sulfo-peroxide Solution+Treatment with Alkali

The procedure of Example 8 was repeated, except that, in order to simulate the deposition of a contaminant onto the surface of the epoxy member, the epoxy member after the treatment with the sulfo-peroxide solution was allowed to stand in air at a high temperature (70° C.) for 240 hr. After the standing in air, the member unfavorably had an increased contact angle θ thereof with pure water, that is, the contact angle θ, which was less than 10° before the standing (immediately after the treatment), was increased to 50° after the standing. This phenomenon is understood to be derived from the deposition of a contaminant in the air on the surface of the member during standing in air.

Subsequently, a 20 wt % aqueous sodium hydroxide solution was prepared from first-grade sodium hydroxide (93%) (manufactured by Kokusan Chemical Works Ltd.). The epoxy member, which had been allowed to stand in air, was immersed in a bath of the aqueous sodium hydroxide solution, and, in this state, the bath was kept at 20° C. for 30 min. Thereafter, the alkali-treated epoxy member was taken out of the bath, washed with pure water, and then dried. The contact angle θ of the alkali-treated epoxy member with pure water was measured and, here again, was found to be less than 10°, indicating that the treatment of the member with an alkali according to the present invention permitted the wettability of the surface of the member, which had been unfavorably deteriorated by the deposition of a contaminant on the surface of the member, to be markedly improved.

### Example 12

### Treatment of Epoxy Member with Sulfo-peroxide Solution+Treatment with Alkali

The procedure of Example 8 was repeated, except that, in order to simulate the deposition of an adhesive-derived contaminant onto the surface of the epoxy member, the epoxy member was exposed to an atmosphere of a high-temperature epoxy adhesive (adhesive: S-40C, heating conditions: at 130° C. for 1 hr) in the same manner as in Example 6. After the exposure to the adhesive atmosphere, the epoxy member unfavorably had an increased contact angle θ thereof with pure water, that is, the contact angle θ, which was less than 10° before the exposure (immediately after the treatment), was increased to 55° after the exposure. This phenomenon is understood to be derived from the deposition of a contaminant derived from the adhesive onto the surface of the member during the exposure of the member to the adhesive atmosphere.

Subsequently, a 20 wt % aqueous sodium hydroxide solution was prepared from first-grade sodium hydroxide (93%) (manufactured by Kokusan Chemical Works Ltd.). The epoxy member, which had been allowed to stand in air, was immersed in a bath of the aqueous sodium hydroxide solution, and, in this state, the bath was kept at 20° C. for 30 min. Thereafter, the alkali-treated epoxy member was taken out of the bath, washed with pure water, and then dried. The contact angle θ of the alkali-treated epoxy member with pure water was measured and, here again, was found to be less than 10°, indicating that the treatment of the member with an alkali according to the present invention permitted the wettability of the surface of the member, which had been unfavorably deteriorated by the deposition of a contaminant on the surface of the member, to be markedly improved.

### Example 13

### Treatment of Epoxy Member with Sulfo-peroxide Solution+Treatment with Alkali

The procedure of Example 8 was repeated, except that, in order to confirm the effect attained by a combination of the treatment with a sulfo-peroxide solution and the treatment with an alkali, the epoxy member after the treatment with a sulfo-peroxide solution was immersed in a bath of a 20 wt % sodium hydroxide solution, and, in this state, the bath was kept at 20° C. for 30 min. The alkali-treated epoxy member was taken out of the bath, washed with pure water, and then dried. The contact angle θ of the dried epoxy member with pure water was measured and found to be less than 5°. This epoxy member was then allowed to stand for 24 hr, and the contact angle θ thereof with pure water was again measured and found to be still less than 5°. These results, together with the fact that the contact angle was 90° before the treatment with the sulfo-peroxide solution and less than 10° immediately after the treatment, show that the alkali-treatment according to the present invention can markedly improve the wettability of the surface of the member and, at the same time, permits the improved wettability to be retained for a long period of time.

### Example 14 (Comparative Example)

### Ultrasonic Cleaning of Polyimide and Epoxy Members

For comparison, the polyimide member prepared in Example 6 and the epoxy member prepared in Example 8 were ultrasonically cleaned by the conventional method to examine whether or not the contact angle could be lowered.

The members under test were placed in a commercially available ultrasonic cleaning device where they were cleaned with acetone for 10 min. After the completion of the cleaning, the contact angle θ of the members with pure water was measured in the following timing:

Timing A: immediately after the washing

Timing B: immediately after replacing acetone with isopropyl alcohol (IPA)

Timing C: immediately after exposure to an atmosphere of a high-temperature adhesive (adhesive: S-40C, heating conditions: at 130° C. for 1 hr)

Timing D: immediately after replacement of acetone with IPA subsequent to ultrasonic cleaning with acetone for 10 min for the second time

The results on the contact angle (°) of the members with pure water are summarized in the following Table 4.

TABLE 4

Timing of measurement

| Member under test | A | B | C | D |
|---|---|---|---|---|
| Polyimide member | 67 | 67 | 82 | 77 |
| Epoxy member | 95 | 87 | 95 | 90 |

From the results given in Table 4, it is apparent that, for both the polyimide and the epoxy member, sole use of ultrasonic cleaning according to the conventional method cannot result in a lowered contact angle.

### Example 15

### Control of Treatment of Filler-containing Epoxy Resin Member with Sulfo-peroxide Solution

A member having a form and a dimension corresponding to a lid of an ink jet head shown in FIG. 1 was injection-molded using a thermosetting epoxy resin containing about 70% of an inorganic powder as a filler. The contact angle of the θ of the filler-containing epoxy member with pure water was measured and found to be 85°.

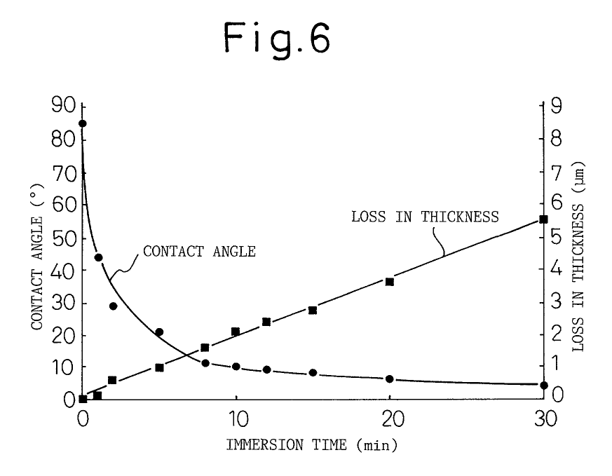

Separately, sulfuric acid (96%) (manufactured by Tokuyama Corporation) for use in electronic industries and aqueous hydrogen peroxide (30%) (manufactured by Santoku Chemical Industries Co., Ltd.) for use in electronic industries were mixed together in a volume ratio of 8:1 to prepare a sulfo-peroxide solution. The molded epoxy member was then immersed in a bath of the sulfo-peroxide solution, and, in this state, the bath was kept at 19° C. for various immersion times as shown in FIG. 6. This resulted in exposure of the filler, incorporated into the epoxy member, onto the surface of the member. The degree of the exposure increased with increasing the immersion time.

Each time when a predetermined immersion time elapsed, the epoxy member was taken out of the sulfo-peroxide solution bath, subjected to ultrasonic cleaning with pure water, and dried by nitrogen blast, followed by measurement of the contact angle. Further, the amount of loss of the epoxy member in terms of loss in thickness was determined based on a difference in mass of the member between before and after the treatment with a sulfo-peroxide solution. Specifically, the difference in mass (corresponding to the amount of eluted epoxy resin) was divided by the surface area of the epoxy member to determine the amount of eluted member per unit surface area, from which, together with the specific gravity and content of the epoxy resin, the loss in thickness of the member by etching was calculated. The results were plotted as the relationship between the time of treatment with the sulfo-peroxide solution and the contact angle of the member with pure water and the loss in thickness of the member and is shown in FIG. 6.

From the results shown in FIG. 6, it is apparent that, for example, when a contact angle of the member with pure water of not more than 30° is contemplated, the time of immersion in the sulfo-peroxide solution should be regulated to not less than 3 min. Further, a loss in thickness in the surface of the member of not more than 3 μμm is contemplated, this can be achieved by regulating the immersion time to not more than 15 min. That is, in the practice of the present invention, the immersion time should be set at 5 to 15 min from the viewpoint of satisfying both hydrophilicity and dimensional stability requirements.

The oxidizing power of the sulfo-peroxide solution changes with the elapse of time. Therefore, the quality control by periodically measuring the amount of eluted member in a certain immersion time enables a member, for an ink chamber, provided with an ink flow passage having hydrophilic nature and dimensional stability to be always provided.

Exposure of a filler caused in this example and the effect attained by this phenomenon will be further described. Most plastics are resistant to usual acids, making it necessary to use an acid having very strong oxidizing power in the acid treatment. In this connection, it should be noted that the sulfo-peroxide solution used in this example has strong oxidizing power even at room temperature and can break the molecular structure of the surface of the epoxy resin to form a polar group at that site. Use of a concentrated sulfuric or nitric acid solution also can result in the formation of a polar group. In this case, however, use of a high temperature of 100° C. or above is necessary for the formation of a polar group and, hence, results in poor workability. Further, additional equipment or the like for providing high temperature conditions is also necessary.

The treatment with a sulfo-peroxide solution as described in this example breaks the molecular structure of the surface of the epoxy resin to form a polar group, such as a carboxyl or hydroxyl group, on the surface of the member. The polar group weakly combines with water molecule through an electrostatic action or a hydrogen bond. Therefore, it is hydrophilic, well wetted by an ink, and, when the member is joined with the aid of an adhesive, can enhance the adhesive strength.

Further, incorporation of an inorganic powder as a filler into the epoxy resin results in the creation of irregularities on the surface of the member, increasing the surface area and increasing the hydrophilicity. The increase in surface area and the anchor effect derived from the irregularities on the surface of the member contributes to a further enhancement in adhesive strength.

### Industrial Applicability

As is apparent from the foregoing description, in the ink jet head of the present invention, the wettability of the ink flow passage in the completed product is good, and, in addition, the good wettability can be maintained for a long period of time. Therefore, when the head is incorporated in a printer and the assembly is used for printing, high print quality can be ensured for a long period of time.

Further, when the member constituting the ink jet head is a plastic member with a filler incorporated therein, simple acid treatment can markedly improve the wettability of the surface of the member and, in addition, the improved wettability can be maintained for a long period of time.

Further, in the ink jet head according to the present invention, the wettability of the ink flow passage in the completed product is good. Further, as a result of the quantitative determination of the plastic material eluted by the acid treatment, in the production process, the dimensional controllability of the member is improved, creating neither troubles associated with remaining air bubbles nor faulty assembling.

1. An ink jet head, for use in an ink jet recording apparatus, comprising an ink chamber, at least part of a member constituting the ink chamber being made of a plastic material having a surface possessing a hydrophilic nature imparted by surface treatment, for introducing a polar group, selected from the group consisting of aid treatment, ultraviolet light-ozone irradiation, and oxygen plasma treatment.

2. The ink jet head according to claim 1, wherein the acid treatment has been performed by applying a mixed solution comprising sulfuric acid and aqueous hydrogen peroxide onto the plastic material.

3. The ink jet head according to claim 2, wherein the acid treatment has been performed by spraying the mixed solution for the acid treatment on the plastic material or by immersing the plastic material in the mixed solution for the acid treatment.

4. The ink jet head according to claim 2 or 3, wherein the mixed solution for the acid treatment has a mixing ratio (volume ratio) of sulfuric acid to aqueous hydrogen peroxide of 2:1 to 10:1.

5. The ink jet head according to any one of claims 1 to 4, wherein the surface treatment for introducing a polar group has been performed before constructing the ink chamber from the plastic material and, after the construction of the ink chamber, an additional hydrophilic nature has been imparted to the surface of the plastic material by treatment with an alkali.

6. The ink jet head according to claim 5, wherein the alkali treatment is alkali cleaning of the ink chamber with a 1 to 20 wt % sodium hydroxide solution.

7. The ink jet head according to any one of claims 1 to 6, wherein the plastic material is a member selected from the group consisting of acrylic resin, epoxy resin, polyethylene, polypropylene, polyester, polyacetal, polycarbonate, polyamide, polyimide, polystyrene, styrene/butadiene resin, acrylonitrile/butadiene/styrene resin, ethylene-propylene rubber, polymethylpentene, polyphenylene sulfide, polyether ketone, and liquid crystalline polymer.

8. The ink jet head according to any one of claims 1 to 6, wherein the plastic material contains a filler incorporated therein.

9. The ink jet head according to claim 8, wherein the filler is a powder or flakes of an organic or inorganic material.

10. The ink jet head according to claim 9, wherein the filler is a member selected from the group consisting of silica, carbon black, titanium oxide, graphite, molybdenum sulfide, fluororesin, clay, talc, a salt of silicic acid, and a salt of carbonic acid.

11. The ink jet head according to any one of claims 1 to 10, wherein, in the treatment of the surface of the plastic material with an acid, the amount of the plastic material eluted by the acid treatment is quantitatively determined to optimally impart the hydrophilic nature to the surface of the plastic material.

12. A process for producing an ink jet head for and ink jet recording apparatus, comprising constructing at least part of an ink chamber, of the head, out of a plastic material and subjecting the surface of the plastic material to surface treatment, for introducing a polar group, selected from the group consisting of acid treatment, ultraviolet light-ozone irradiation, and oxygen plasma treatment.

13. The process according to claim 12, wherein the acid treatment has been performed by applying a mixed solution comprising sulfuric acid and aqueous hydrogen peroxide onto the plastic material.

14. The process according to claim 13, wherein the acid treatment has been performed by spraying the mixed solution for the acid treatment on the plastic material or by immersing the plastic material in the mixed solution for the acid treatment.

15. The process according to claim 13 or 14, wherein the mixed solution for the acid treatment has a mixing ratio (volume ratio) of sulfuric acid to aqueous hydrogen peroxide of 2:1 to 10:1.

16. The process according to any one of claims 12 to 15, wherein the surface treatment for introducing a polar group has been performed before constructing the ink chamber from the plastic material and, after the construction of the ink chamber, an additional hydrophilic nature has been imparted to the surface of the plastic material by treatment with an alkali.

17. The process according to claim 16, wherein the alkali treatment is alkali cleaning of the interior of the ink chamber with a 1 to 20 wt % sodium hydroxide solution.

18. The process according to any one of claims 12 to 17, wherein the plastic material contains a filler incorporated therein.

19. The process according to any one of claims 12 to 18, wherein, in the treatment of the surface of the plastic material with an acid, the amount of the plastic material eluted by the acid treatment is quantitatively determined to optimally impart the hydrophilic nature to the surface of the plastic material.
